(19) United States
(12) Patent Application Publication
(10) Pub. No.: US 2016/0068035 A1
(43) Pub. Date: Mar. 10, 2016

(54) TWIST BEAM WITH JOINED INNER AND OUTER PARTS

(71) Applicants: Prasad RAO, (US); Suresh KALE, (US); Punith Jagadish KUMAR, (US); Dhiren BEHERA, (US); Vallishan GUNDAPPA, (US); MAGNA INTERNATIONAL INC., Aurora (CA)

(72) Inventors: PRASAD RAO, Bangalore, Karnataka (IN); SURESH KALE, Pune, Maharashtra (IN); PUNITH JAGADISH KUMAR, Mysore, Karnataka (IN); DHIREN BEHERA, Pune, Maharashtra (IN); VALLISHAN GUNDAPPA, Bangalore, Karnataka (IN)

(21) Appl. No.: 14/784,479

(22) PCT Filed: Apr. 16, 2014
(86) PCT No.: PCT/US14/34325

§ 371 Date: Oct. 14, 2015

(30) Foreign Application Priority Data
Apr. 16, 2013 (IN) 1700/CHE/2013

(51) Int. Cl. B60G 11/18; B23K 26/21; B23K 31/02; B23K 9/00

(52) U.S. Cl. CPC B60G 11/183; B23K 9/00; B23K 26/21; B23K 31/02; B60G 2200/23; B60G 2202/136; B60G 2206/0122; B60G 2206/20; B60G 2206/8201

(57) ABSTRACT

A twist beam (22) for a rear suspension assembly (20) includes an outer beam part (24) and an inner beam part (26) each stamped from a sheet of steel or steel alloy. The beam parts (24, 26) both present an inverted U-shaped cross-section. The inner beam part (26) is disposed between side walls (56, 72) of the outer beam part (24), and the parts (24, 26) present an inverted U-shaped gap (28) therebetween. The inner beam part (26) includes a plurality of ribs (84) to modify the roll stiffness of the twist beam (22). Each part (24, 26) includes an outwardly flared section (62, 76) adjacent an outer side edge (58, 74). The parts (24, 26) are typically joined by spot welds (86) along the flared sections (62, 76).

### CROSS-REFERENCE TO PRIOR APPLICATIONS

This U.S. National Stage patent application claims the benefit of PCT International Patent Application Serial No. PCT/US2014/034325 filed Apr. 16, 2014 entitled “Twist Beam With Joined Inner And Outer Parts,” which claims the benefit of IN Provisional Patent Application Serial No. 1700/CHE/2013 filed Apr. 16, 2013, entitled “Twist Beam With Joined Inner And Outer Parts,” the entire disclosures of the applications being considered part of the disclosure of this application and hereby incorporated by reference.

### BACKGROUND OF THE INVENTION

1. Field of the Invention

The subject invention relates to a twist beam for an automotive vehicle, and a method of manufacturing the twist beam.

2. Related Art

A rear suspension assembly of an automotive vehicle includes a pair of longitudinal control arms connected to a body of the vehicle and a pair of trailing arms carrying stub-axles of the vehicle. The control arms and the trailing arms are interconnected by a twist beam, also referred to as a cross beam or a torsion beam. Twist beams of rear suspension assemblies typically comprise a cross-section having an O-shape, C-shape, U-shape, or V-shape, which can be either open or closed. The twist beam should also be rigid enough to prevent bending yet flexible enough to allow torsion. Accordingly, the twist beam is not only a structural member, but also acts as a torsion spring. Example twist beams are disclosed in U.S. Patent Application Publication No. 2008/0191443 and U.S. Pat. Nos. 8,205,898 and 8,585,067.

Twist beams experience a significant amount of stress during use in the automotive vehicle, due to twisting and other factors. Therefore, maximum stress levels, especially those due to twisting, require a minimum material thickness and thus dictate the weight of the twist beam. However, the weight of the twist beam is preferably kept as low as possible since it contributes to the total weight of the automotive vehicle.

The twist beam also controls a roll rate or roll stiffness of the vehicle, which affects the ride and handling of the vehicle. The twist beam provides the roll stiffness by twisting as the trailing arms move vertically relative to one another. The roll stiffness is analogous to a vehicle's ride rate, but for actions that include lateral accelerations, causing a vehicle's sprung mass to roll. Roll stiffness is expressed as torque per degree of roll of the vehicle sprung mass, and is typically measured in Nm/degree. The roll stiffness of a vehicle does not change the total amount of weight transfer of the vehicle, but shifts the speed at which weight is transferred and percentage of weight transferred from a particular axle to another axle through the vehicle chassis. Generally, the higher the roll stiffness on an axle of a vehicle, the faster and higher percentage the weight transfer on that axle. A slower weight transfer reduces the likelihood of vehicle rollover conditions.

The dimensions and design of the twist beam have a significant influence on the roll stiffness. Increasing the thickness of the twist beam can increase the roll stiffness, but this also increases the weight and manufacturing costs. Stabilizer bars are oftentimes used to achieve the desired roll stiffness, especially in twist beams having an open U-shaped or V-shaped cross-section. A closed V-shaped cross-section or a squashed closed profile can also provide adequate roll stiffness. However, twist beams including the stabilizer bar or closed cross-section are costly because they require a complex, controlled, and consistent manufacturing process.

### SUMMARY OF THE INVENTION

The invention provides a twist beam comprising an outer beam part including an outer base portion extending longitudinally along an axis between opposite outer ends. The outer beam part includes a pair of outer side walls spaced from one another by the outer base portion and each extending longitudinally along the axis between the opposite outer ends. The outer side walls also extend transversely from the outer base portion to present an opening therebetween.

The twist beam also includes an inner beam part disposed in the opening between the outer side walls of the outer beam part. The inner beam part includes an inner base portion extending longitudinally along the outer base portion between opposite inner ends. The inner beam part includes a pair of inner side walls spaced from one another by the inner base portion and each extending longitudinally along the axis between the opposite inner ends. The inner side walls also extend transversely from the inner base portion to present an opening therebetween. The inner side walls of the inner beam part are joined to the outer side walls of the outer beam part.

The invention also provides a method of manufacturing the twist beam. The method includes providing the outer beam part and the inner beam part, and disposing the inner beam part in the opening presented by the outer side walls of the outer beam part. The method then includes joining the inner side walls of the inner beam part to the outer side walls of the outer beam part.

The twist beam of the present invention provides the advantage of meeting roll stiffness requirements with reduced weight and lower manufacturing costs, compared to twist beams formed with a stabilizer bar, closed V-shaped cross-section, or a squashed closed profile.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a perspective view of a suspension assembly including a twist beam with a plurality of spot welds according to one exemplary embodiment of the invention;

FIG. 1B is top view of a portion of the suspension assembly of FIG. 1A;

FIG. 1C is a perspective view of a portion of the suspension assembly of FIG. 1A showing the spot welds along an outer surface of an outer beam part;

FIG. 1D is a perspective view of a portion of the suspension assembly of FIG. 1A showing the spot welds along an inner surface of an inner beam part;

FIG. 2A is a perspective view of the twist beam of FIG. 1A;

FIG. 2B is an exploded view of the twist beam of FIGS. 1A and 2A showing the outer beam part and the inner beam part;

FIG. 3A is a cross-sectional view of the twist beam of FIG. 2A along line A-A;

FIG. 3B is a cross-sectional view of the twist beam of FIG. 2A along line B-B;

FIG. 3C is a cross-sectional view of the twist beam of FIG. 2A along line C-C;

FIG. 3D is a top view of the inner beam part shown in FIG. 2B; and

FIG. 3E is a side view of the twist beam of FIG. 2A showing the plurality of spot welds.

### DETAILED DESCRIPTION

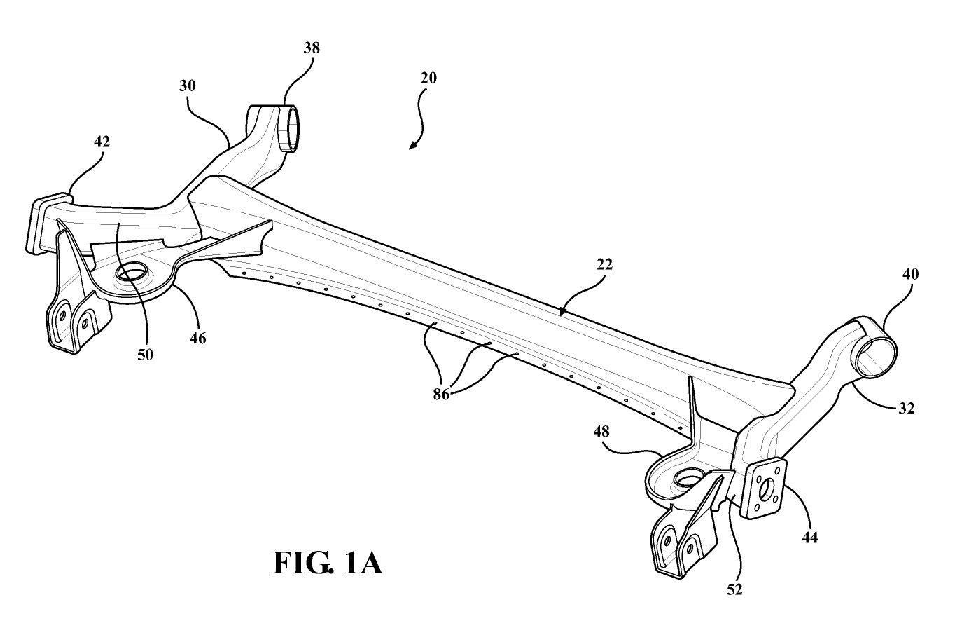

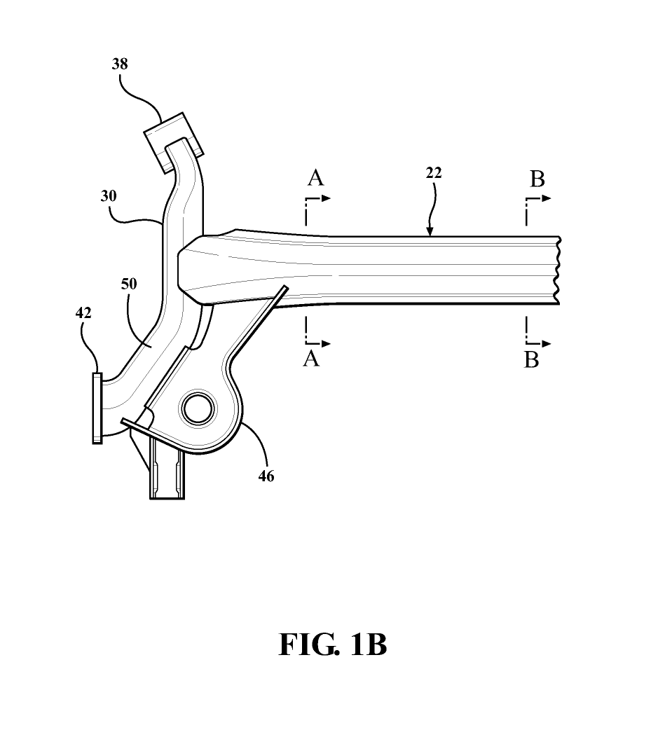

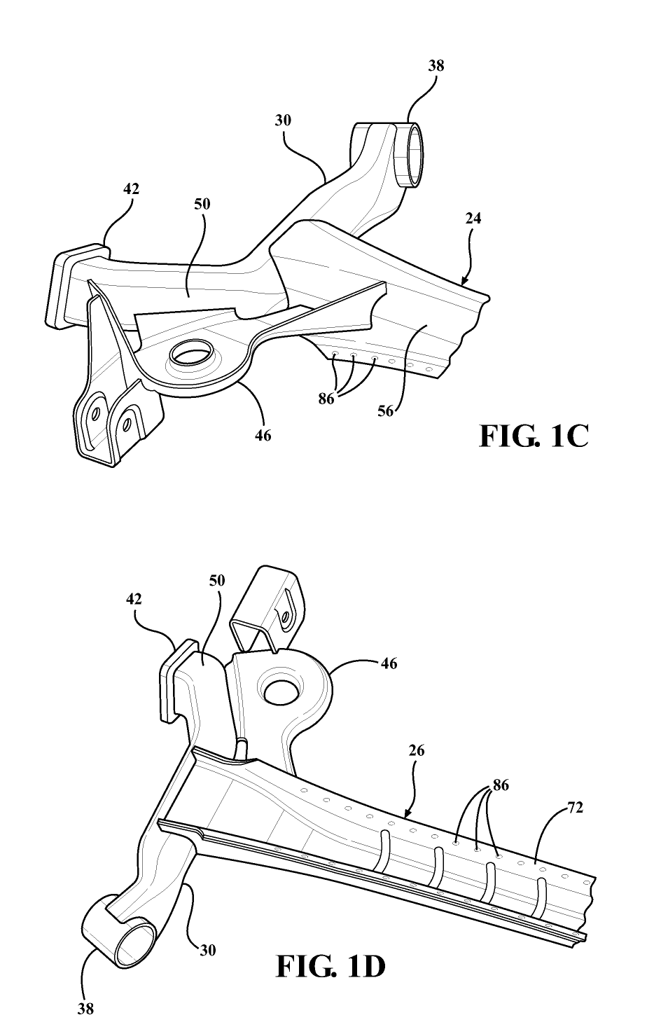

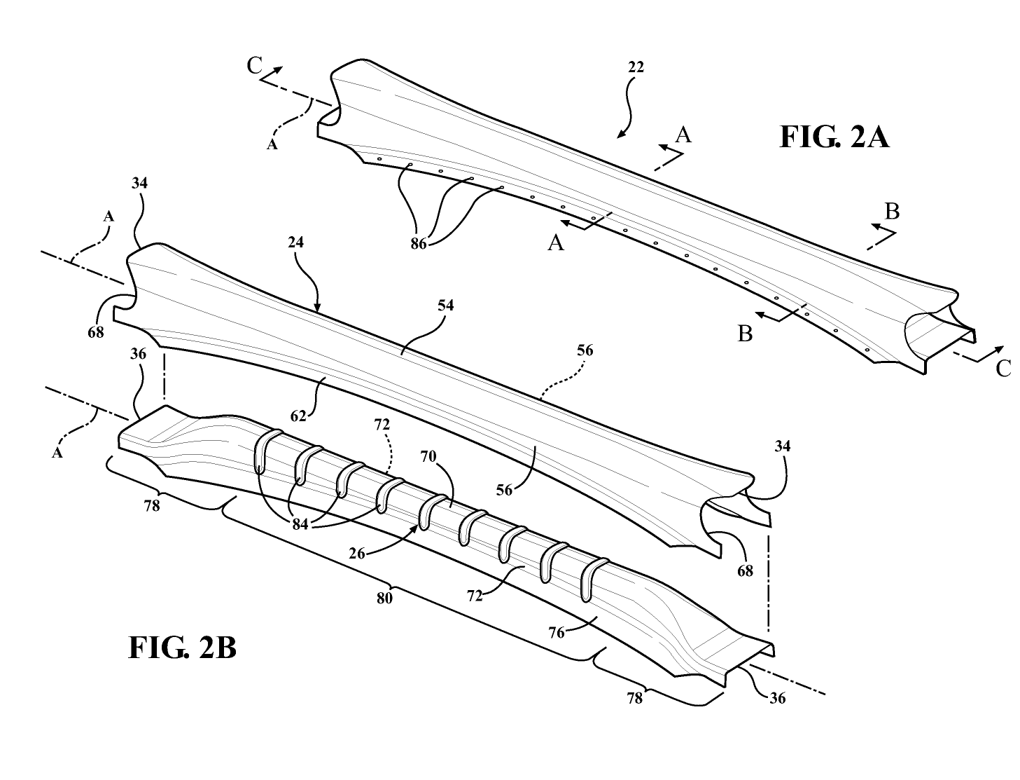

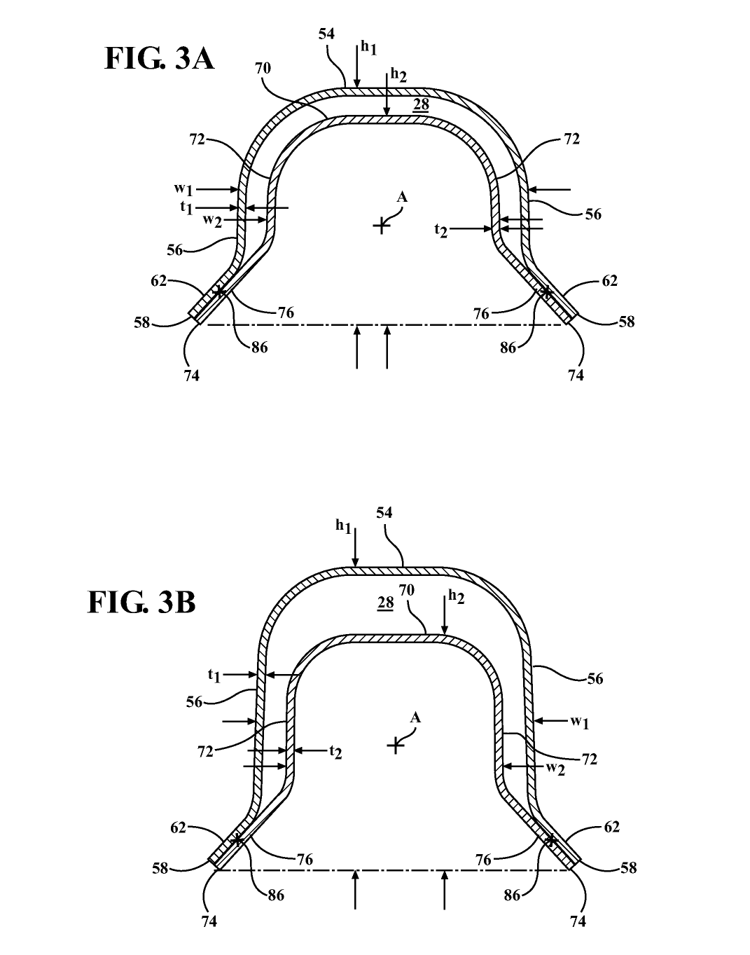

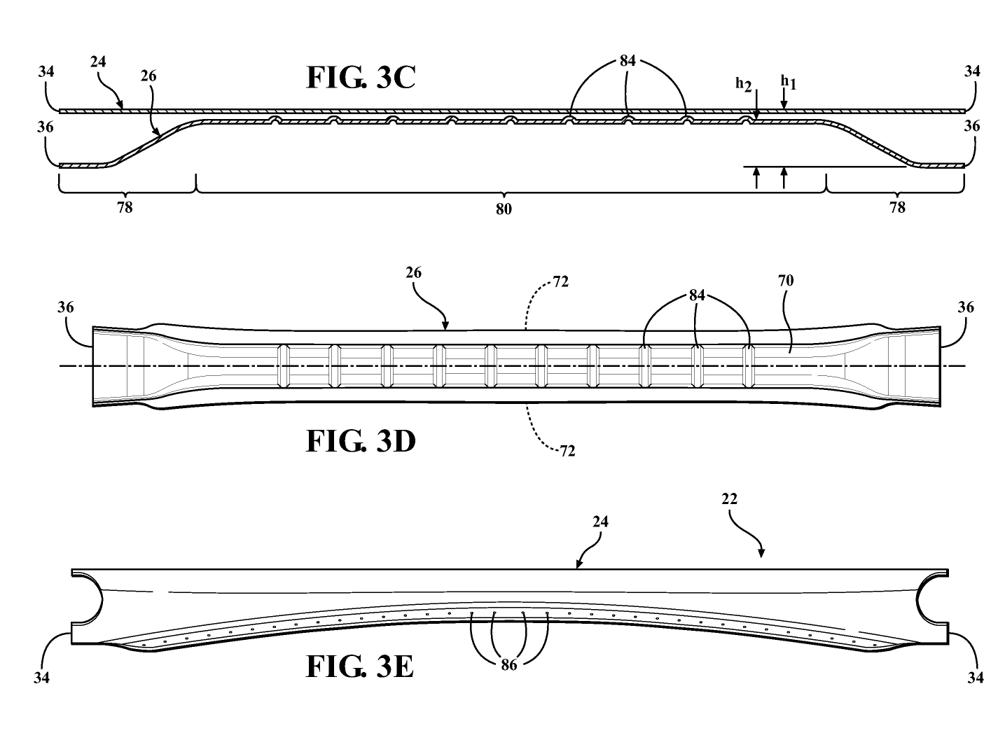

A rear suspension assembly 20 for an automotive vehicle according to one embodiment of the invention is generally shown in FIGS. 1A-1D. The suspension assembly 20 includes a twist beam 22 comprising an outer beam part 24 and an inner beam part 26, as best shown in FIGS. 2A and 2B. The outer beam part 24 and the inner beam part 26 are joined together to present an inverted U-shaped gap 28 therebetween, as shown in FIGS. 3A and 3B. The twist beam 22 meets roll stiffness requirements with reduced weight and lower manufacturing costs, compared to twist beams formed with a stabilizer bar, closed V-shaped cross-section, or squashed close profile. For example, the twist beam 22 of FIG. 1A can provide a weight of 7.5 kg and a roll stiffness of 551 Nm/degree.

As shown in FIG. 1A, the suspension assembly 20 includes a first control arm 30 and a second control arm 32 each extending between opposite ends. The suspension assembly 20 also includes a first wheel mounting member 38 and a second wheel mounting member 40 aligned with one another and each connected to one end of the respective control arm 30, 32. A first spindle bracket 42 is connected to the first control arm 30 adjacent the end opposite the first wheel mounting member 38, and a second spindle bracket 44 is connected to the second control arm 32 adjacent the end opposite the second wheel mounting member 40. A first spring bracket 46 is connected to the first control arm 30 adjacent the first spindle bracket 42, and a second spring bracket 48 is connected to the second control arm 32 adjacent the second spindle bracket 44. The suspension assembly 20 also includes a first trailing arm 50 and a second trailing arm 52 each connected to the respective spindle bracket 42, 44 and extending opposite the respective control arm 30, 32. Although FIG. 1A shows the twist beam 22 in a rear suspension assembly 20, the twist beam 22 could be used in other types of suspension assemblies.

The twist beam 22 of the suspension assembly 20 includes the outer beam part 24 and the inner beam part 26, as shown in FIG. 2B. The outer beam part 24 and inner beam part 26 are preferably stamped from a sheet of steel or steel alloy, but can be formed of another metal. The outer beam part 24 includes an outer base portion 54 presenting an arcuate shape and extending longitudinally along the axis A between opposite outer ends 34. The outer beam part 24 also includes a pair of outer side walls 56 spaced from one another by the outer base portion 54 and each extending longitudinally along the axis A between the opposite outer ends 34. Each outer side wall 56 also extends transversely from the outer base portion 54 to an outer side edge 58 to present an opening between the outer side walls 56, as best shown in FIGS. 3A and 3B. The outer base portion 54 and the outer side walls 56 preferably present an inverted open U-shaped cross-section. Each outer side wall 56 includes an outer flared section 62 extending outwardly adjacent the associated outer side edge 58 along a majority of the length of the outer beam part 24. In the portion of the outer beam part 24 adjacent the outer ends 34, the outer side walls 56 are typically straight and do not include the outer flared section 62. The outer beam part 24 is preferably symmetric relative to a plane extending along the longitudinal axis A between the outer ends 34. However, the outer base portion 54 and outer side walls 56 of the twist beam 22 could present an open cross-section having various different shapes.

The outer base portion 54 and the outer side walls 56 of the outer beam part 24 together present an outer surface and an oppositely facing inner surface spaced from one another by the outer side edges 58. The inner surface and the outer surface present a thickness t₁ therebetween, as shown in FIGS. 3A and 3B. In one embodiment, the thickness t₁ is about 2 mm to 3 mm. The outer surface of the outer base portion 54 is typically flat in a center area along the center axis A and generally convex from the flat center area to the outer side walls 56. The inner surface of the outer base portion 54 is also flat in a center area along the center axis A and generally concave from the flat center area to the outer side walls 56. As shown in FIGS. 3A and 3B, the outer base portion 54 typically presents a width w₁ extending perpendicular to the center axis A and from one outer side wall 56 to the other outer side wall 56. The width w₁ of the outer beam part 24 typically decreases slightly from the outer ends 34 toward the middle of the outer beam part 24. The outer beam part 24 also typically presents a height h₁ extending from between the outer side edges 58 to the outer surface of the outer base portion 54, as shown in FIGS. 3A-3C. The height h₁ of the outer beam part 24 is typically constant between the opposite outer ends 34. In addition, the outer side walls 56 of the outer beam part 24 define a socket 68, as shown in FIG. 2B, at each outer end 34 for receiving one of the control arms 30, 32.

The inner beam part 26 of the twist beam 22 is disposed in the opening between the outer side walls 56 of the outer beam part 24 to present the inverted U-shaped gap 28 therebetween, as best shown in FIGS. 3A and 3B. The inner beam part 26 includes an inner base portion 70 presenting an arcuate shape and extending longitudinally along the axis A between opposite inner ends 36. The middle and the inner ends 36 of the inner beam part 26 are typically aligned with the middle and the outer ends 34 of the outer beam part 24. The inner beam part 26 also includes a pair of inner side walls 72 spaced from one another by the inner base portion 70 and each extending longitudinally along the axis A between the opposite inner ends 36. Each inner side wall 72 also extends transversely from the inner base portion 70 to an inner side edge 74 to present an opening between the inner side walls 72. The inner base portion 70 and the inner side walls 72 preferably present an inverted open U-shaped cross-section. Each inner side wall 72 includes an inner flared section 76 extending outwardly adjacent the associated inner side edge 74 along a majority of the length of the inner beam part 26. The inner side walls 72 are typically straight and do not include the inner flared section 76 adjacent the inner ends 36. The inner beam part 26 is preferably symmetric relative to a plane extending along the longitudinal axis A between the inner ends 36. However, the inner base portion 70 and inner side walls 72 of the twist beam 22 could present an open cross-section having various different shapes.

The inner base portion 70 and the inner side walls 72 of the inner beam part 26 together present an outer surface and an oppositely facing inner surface spaced from one another by the inner side edges 74. The inner surface and the outer surface present a thickness t₂ therebetween, as shown in FIGS. 3A and 3B. In one embodiment, the thickness t₂ is about 2 mm to 3 mm.

The outer surface of the inner beam part 26 is spaced from the inner surface of the outer beam part 24 by the inverted U-shaped gap 28. The dimensions of the gap 28 between the inner beam part 26 and outer beam part 24 can vary along the length of the twist beam 22, but the length of the gap 28, i.e. the distance between the inner beam part 26 and the outer beam part 24, is typically greater than the thickness t of each beam part 24, 26. As shown in FIGS. 3A and 3B, the gap 28 includes a first gap area between the outer base portion 54 and the inner base portion 70, a second gap area between one of the outer side walls 56 and the adjacent inner side wall 72; and a third gap area between the other outer side wall 56 and the adjacent inner side wall 72. In the exemplary embodiment shown in FIG. 2A, the size of the gap 28 is greater adjacent the ends 34, 36 of the twist beam 22, for example along line B-B, than in the center of the twist beam 22, for example along line A-A.

The inner surface of the inner base portion 70 is typically flat in a center area along the center axis A and generally convex from the flat center area to the inner side walls 72. The inner surface of the inner base portion 70 is also flat in a center area along the center axis A and generally concave from the flat center area to the inner side walls 72. As shown in FIGS. 3A and 3B, the inner beam part 26 typically presents a width w₂ extending perpendicular to the center axis A and from one inner side wall 72 to the other inner side wall 72. The width w₂ of the inner beam part 26 typically decreases slightly from the inner ends 36 toward the middle of the inner beam part 26, just like the outer beam part 24.

As shown in FIGS. 2B and 3C, the inner beam part 26 includes end sections 78 each extending from one of the inner ends 36 toward the opposite inner end 36, and a middle section 80 disposed between the end sections 78. The inner beam part 26 presents a height h₂ extending from between the inner side edges 74 to the outer surface of the inner base portion 70, as shown in FIGS. 3A-3C. The height h₂ of the inner beam part 26 is typically constant along the middle section 80 and decreases from the middle section 80 along the end sections 78 toward the inner ends 36, as shown in FIG. 3C. In addition, the inner base portion 70 presents a flat surface adjacent each inner end 36 so that the sockets 68 presented by the outer side walls 56 are unobstructed and are able to receive the control arms 30, 32.

In one preferred embodiment, shown in FIGS. 2B, 3C, and 3D, the inner beam part 26 includes a plurality of ribs 84 spaced from one another along the inner base portion 70. The ribs 84 are also spaced slightly from the inner surface of the outer beam part 24, as shown in FIG. 3C. The ribs 84 are typically disposed in the middle section 80 of the inner beam part 26, but not the end sections 78. In addition, the ribs 84 typically extend perpendicular to the center axis across the entire inner base portion 70 and along a portion of the inner side walls 72, but not adjacent the inner side edges 74. The dimensions of the ribs 84 can be modified to change the roll stiffness provided by the twist beam 20. For example, the height, length, and width of each rib 84 can be modified to achieve the desired roll stiffness. The location of the ribs 84 along the length of the inner beam part 26 can also be modified to change the roll stiffness.

Once the inner beam part 26 is disposed between the outer side walls 56, the inner beam part 26 and the outer beam part 24 are joined together to form the twist beam 22, preferably by spot welding. The beam parts 24, 26 are typically joined along the side walls 56, 72 adjacent the side edges 58, 74. As shown in FIGS. 1, 2A, 3A, 3B, and 3E, a plurality of spot welds 86 join the inner flared section 76 of each inner side wall 72 to the outer flared section 62 of the adjacent outer side wall 56. The spot welds 86 are spaced from one another along the length of the twist beam 22. The spot welds 86 also extend from the outer surface of the outer beam part 24 through the side walls 56, 72 and to the inner surface of the inner beam part 26, as shown in FIGS. 1C and 1D. The spot welds 86 are typically metal inert gas (MIG) welds or laser welds, but can be another type of weld. In addition, the inner beam part 26 and outer beam part 24 can alternatively be joined together by another method, such as a continuous weld or an adhesive.

The invention also provides a method of manufacturing the twist beam 22 comprising the outer beam part 24 and inner beam part 26 joined together to present the inverted U-shaped gap 28 therebetween. The method first includes providing the outer beam part 24 and the inner beam part 26. The beam parts 24, 26 are typically formed by stamping a sheet of steel or steel alloy. Stamping provides the flexibility to vary the dimensions, such as the section size, width w, thickness t, and height h, of the inner beam part 26 and outer beam part 24. In one embodiment, the inner beam part 26 and outer beam part 24 are stamped from tailor welded blanks. However, the outer beam part 24 and inner beam part 26 can be formed by other methods.

The method next includes disposing the inner beam part 26 in the opening presented by the outer side walls 56 of the outer beam part 24. The step of disposing the inner beam part 26 in the opening presented by the outer side walls 56 includes spacing the outer surface of the inner base portion part 70 from the inner surface of the outer base portion 54. Once the inner beam part 26 is disposed in the opening, the method includes joining the inner side walls 72 of the inner beam part 26 to the outer side walls 56 of the outer beam part 24. The joining step typically includes welding the inner flared sections 76 of the inner side walls 72 to the outer flared sections 62 of the outer side walls 56, preferably by spot welding. The spot welding step includes welding each outer side wall 56 to the adjacent inner side wall 72 in a plurality of spots spaced from one another along the associated flared sections 62, 76 adjacent the associated side edges 58, 74. The spot welding can include metal inert gas (MIG) welding, laser welding, or another type of welding. Alternatively, a continuous weld can join the parts 24, 26 together. According to another alternative embodiment, the joining step includes another joining technique, such as disposing an adhesive between the inner side walls 72 and outer side walls 56.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A twist beam, comprising:
an outer beam part including an outer base portion extending longitudinally along an axis between opposite outer ends;
said outer beam part including a pair of outer side walls spaced from one another by said outer base portion and each extending longitudinally along said axis between said opposite outer ends and transversely from said outer base portion to present an opening therebetween;
an inner beam part disposed in said opening between said outer side walls of said outer beam part;
said inner beam part including an inner base portion extending longitudinally along said outer base portion between opposite inner ends;
said inner beam part including a pair of inner side walls spaced from one another by said inner base portion and each extending longitudinally along said axis between said opposite inner ends and transversely from said inner base portion to present an opening therebetween; and
said inner side walls of said inner beam part being joined to said outer side walls of said outer beam part.

2. The twist beam of claim 1 including spot welds joining said outer side walls to said inner side walls.

3. The twist beam of claim 2, wherein each of said outer side walls extends from said outer base portion to an outer side edge, each of said inner side walls extends from said inner base portion to an inner side edge, each of said side walls includes a flared section extending outwardly adjacent the associated side edge, and each of said side walls includes a plurality of said spot welds spaced from one another along said flared sections.

4. The twist beam of claim 1, wherein said outer base portion and said inner base portion provide a gap therebetween.

5. The twist beam of claim 4, wherein each of said beam parts has a thickness, and the length of said gap extending from said inner base portion to said outer base portion is greater than said thickness of each of said beam parts along at least a portion of said longitudinal axis.

6. The twist beam of claim 4, wherein said outer side walls and said inner side walls present said gap therebetween.

7. The twist beam of claim 6, wherein said gap has an inverted U-shape.

8. The twist beam of claim 6, wherein said gap increases in a direction moving from the middle of said twist beam toward said ends.

9. The twist beam of claim 1, wherein each of said beam parts presents a width, and the width decreases in a direction moving away from said ends of said parts.

10. The twist beam of claim 1, wherein an outer surface of said outer base portion is flat in a center area and convex from said flat center area to said outer side walls; and said inner base portion is flat in a center area and convex from said flat center area to said outer side walls.

11. The twist beam of claim 1, wherein said inner side walls extend from said inner base portion to inner side edges; said inner beam part presents a height extending perpendicular to said axis from between said inner side edges to said inner base portion; said inner beam part includes end sections each extending from one of said inner ends toward the opposite inner end and a middle section disposed between said end sections; and wherein said height of said end sections decreases from said middle section toward said adjacent inner end.

12. The twist beam of claim 11, wherein said inner base portion presents a flat surface adjacent each inner end; and said outer side walls of said outer beam part define a socket at each outer end.

13. The twist beam of claim 1, wherein said inner beam part includes a plurality of ribs spaced from one another along said inner base portion.

14. The twist beam of claim 13, wherein said ribs extend perpendicular to said axis across said inner base portion and along at least a portion of said inner side walls.

15. A suspension assembly including a twist beam, said twist beam comprising:
an outer beam part including an outer base portion extending longitudinally along an axis between opposite outer ends;
said outer beam part including a pair of outer side walls spaced from one another by said outer base portion and each extending longitudinally along said axis between said opposite outer ends and transversely from said outer base portion to present an opening therebetween;
an inner beam part disposed in said opening between said outer side walls of said outer beam part;
said inner beam part including an inner base portion extending longitudinally along said outer base portion between opposite inner ends;
said inner beam part including a pair of inner side walls spaced from one another by said inner base portion and each extending longitudinally along said axis between said opposite inner ends and transversely from said inner base portion to present an opening therebetween; and
said inner side walls of said inner beam part being joined to said outer side walls of said outer beam part.

16. The suspension assembly of claim 15 including a first control arm and a second control arm, wherein said twist beam extends between said first control arm and said second control arm; a pair of wheel mounting members, each wheel mounting member being connected to one of said control arms; a pair of spindle brackets each connected to one of said control arms; a pair of spring brackets each connected to one of said control arms; and a pair of trailing arms each connected to said respective spindle bracket.

17. A method of manufacturing a twist beam, comprising the steps of:
providing an outer beam part including an outer base portion extending longitudinally along an axis between opposite outer ends, and a pair of outer side walls spaced from one another by the outer base portion and each extending longitudinally along the axis between the opposite outer ends and transversely from the outer base portion to present an opening therebetween;
providing an inner beam part including an inner base portion extending longitudinally along an axis between opposite inner ends, and a pair of inner side walls spaced from one another by the inner base portion and each extending longitudinally along the axis between the opposite inner ends and transversely from the inner base portion to present an opening therebetween;
disposing the inner beam part in the opening presented by the outer side walls of the outer beam part; and
joining the inner side walls of the inner beam part to the outer side walls of the outer beam part.

18. The method of claim 17, wherein the step of joining the inner side walls of the inner beam part to the outer side walls of the outer beam part includes presenting a gap between the outer base portion and the inner base portion.

19. The method of claim 17, wherein the step of joining the inner side walls of the inner beam part to the outer side walls of the outer beam part includes welding the inner beam part to the outer beam part or disposing an adhesive between the inner beam part and the outer beam part.

20. The method of claim 19, wherein the step of joining the inner side walls of the inner beam part to the outer side walls of the outer beam part includes welding a plurality of spots along the side walls, and the spot welding step includes metal inert gas (MIG) welding or laser welding.
